(19) United States
(12) Patent Application Publication
(10) Pub. No.: US 2012/0001425 A1
(43) Pub. Date: Jan. 5, 2012

(54) Fluid Line Connecting Fitting

(76) Inventor: Frank Ching King Lee, Hacienda Heights, CA (US)

(21) Appl. No.: 12/829,818

(22) Filed: Jul. 2, 2010

(51) Int. Cl. F16L 21/00

(52) U.S. Cl. 285/399

(57) ABSTRACT

A hydraulic coupling suitable for high pressure gas service has a male member, a female member, and a coupling member, where the male member and female member have corresponding sealing faces which mate together. The sealing face of the male member has a protruding lip member, which defines a primary seal and a second seal backwardly disposed from the primary seal. Upon application of axial force, which drives the two sealing faces together, the protruding lip member makes engaging contact with a portion of the sealing face of the female member. Upon application of further axial force, the second sealing member is deflected into a portion of the female sealing face, such that both the first sealing member and the second sealing member are in sealing contact with the female sealing face.

### BACKGROUND

The present invention relates to fluid line coupling devices which are utilized for connecting segments of pneumatic lines, hydraulic lines, fuel lines or other fluid line segments, tubes, ducts, conduits, and the like. More specifically, this invention relates to a coupling having primary and secondary sealing structures which provide for high pressure service while maintaining a leak-free fluid connection.

A variety of coupling devices are known in the art for connecting pressurized fluid line segments and the like. Many of these devices have been specifically designed to prevent inadvertent disassembly and catastrophic leakage during operation. The known devices generally comprise opposing seal faces which are placed into sufficient axial preload with a coupling member to resist, with sufficient safety factor, the forces imposed by the expected internal pressure of the fluid. However, as the applications become more extreme, the need for highly reliable connectors increases. For example, the high pressure sealing of a gas having a small molecular structure, such as helium, in a critical application, such as in space applications, requires couplings which provide highly reliable sealing capacity. The present invention provides such capability.

### SUMMARY OF THE INVENTION

Embodiments of the presently disclosed invention comprise a male member, a female member, and a coupling member. Both the male member and the female member comprise elongated bodies having outside walls, central bores extending through the respective lengths of the members, and inside walls bounding the central bores. The male member and female members each comprise matching seal faces, where the sealing face of the male member comprises a protruding lip portion, which defines a first sealing member. The protruding lip portion makes the first sealing contact with the sealing face of the female member. The sealing face of the male member further comprises a second sealing member, which comes into sealing contact with the sealing face of the female member upon application of additional axial force. A circumferential surface is defined between the first sealing member and the second sealing member, where this circumferential surface comprises a concavity which is oriented toward the outer wall of the male member.

The sealing face of the male member further comprises a shoulder member which extends circumferentially around the male sealing face, defining a shoulder member surface. The shoulder member surface extends normally from the male member outside wall toward, but not reaching, the inside wall of the male member

The female member comprises a sealing face which, upon application of a sufficient axial force, engages the first sealing member and the second sealing member in sealing contact. The axial force may be applied by the coupling member which connects the male member to the female member. Upon rotation, the coupling member imposes the axial force for engaging the female sealing face into sealing contact with the first sealing member. Following the engagement of the protruding lip portion with the sealing face of the female member and the application of further axial force, the second sealing member is deflected into a portion of the female sealing face, such that both the first sealing member and the second sealing member are in sealing contact with the female sealing face.

### BRIEF DESCRIPTION OF THE DRAWINGS

FIG. 1 shows a side sectional view of an embodiment of the present invention, showing the male, female, and coupling members.

FIG. 2 shows a front view of the male member, viewed from the sealing face.

FIG. 3 shows a front view of the female member, viewed from the sealing face.

FIG. 4 shows a side sectional view of the embodiment of FIG. 1, showing the male and female members in an assembled configuration.

FIGS. 5-7 show the sequence of the engagement of the sealing faces of the male and female members as the coupling member is tightened and axial force applied.

FIG. 6A shows an enlarged view of FIG. 6.

FIG. 7A shows an enlarged view of FIG. 7.

### DETAILED DESCRIPTION OF THE EMBODIMENTS

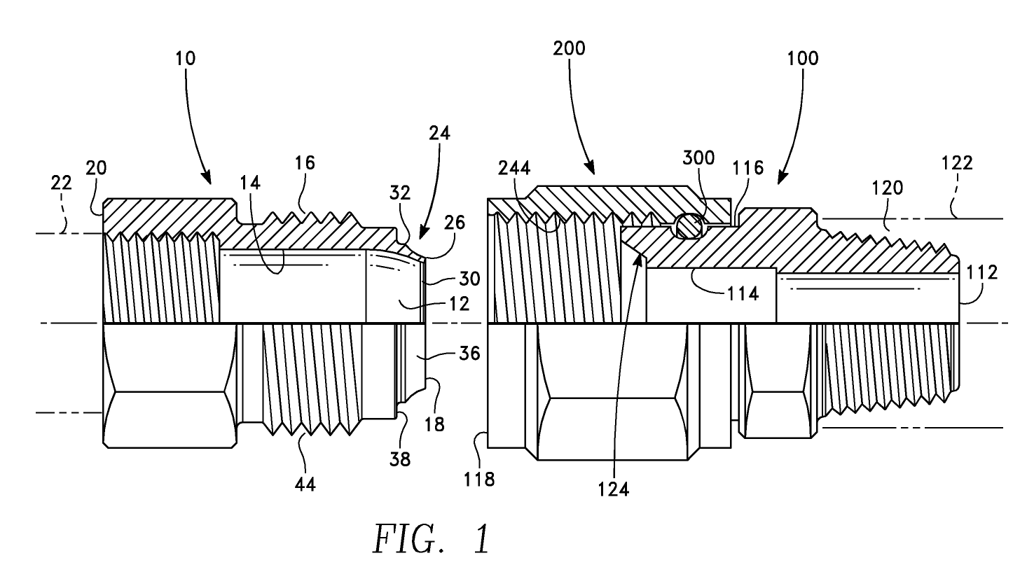

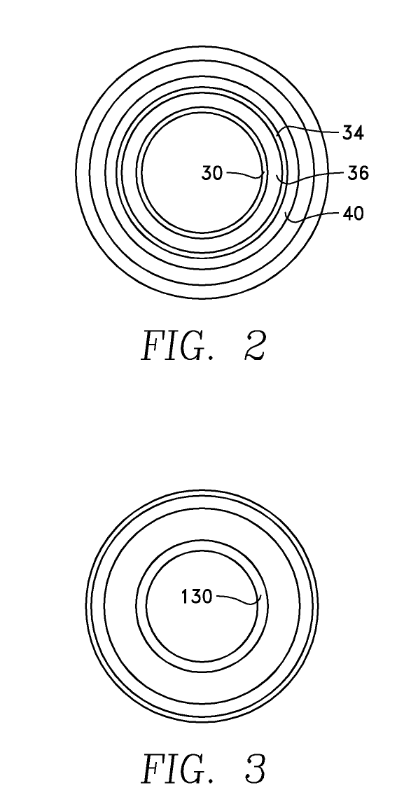

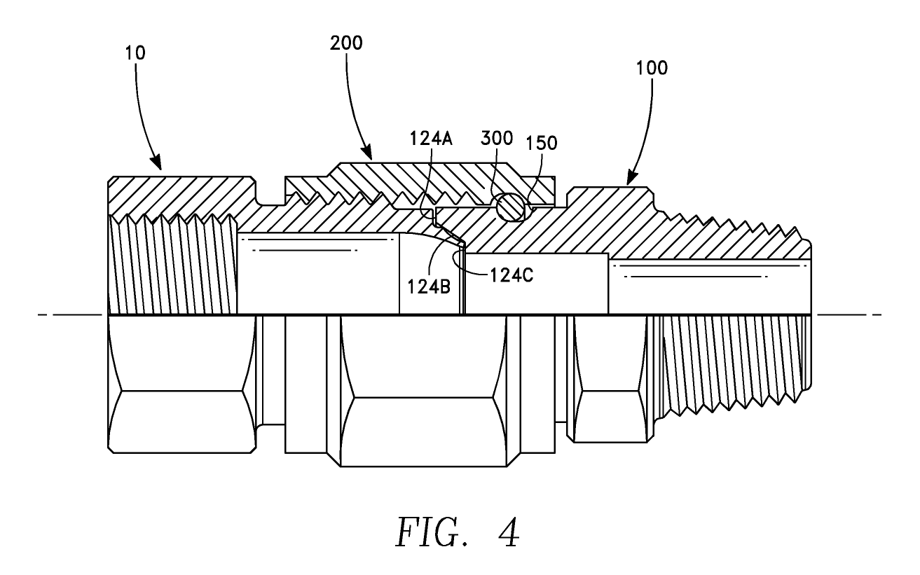

Referring now to the Figures, FIG. 1 depicts the male member 10, the female member 100, and the coupling member 200. Male member 10 has an elongated body having a central bore 12 which extends from end-to-end of the male member. Male member 10 has an inside wall 14 which bounds the central bore 12, and an outside wall 16. The male member comprises a first end 18 which mates to the female member 100 and a second end 20, which will typically be attached to the end of a fluid bearing conduit 22. The first end 18 has a male sealing face 24. The male sealing face 24 is generally in the shape of a frustrum of a cone, although the seal face comprises two seal members which modify the otherwise generally conical shape. The first sealing member 26 is a protruding lip structure which protrudes forwardly from the first end 18. It is to be appreciated that if the protruding lip structure of first sealing member 26 shown in the sectional view is rotated to form a solid, an engagement surface 30 is defined at the leading edge 28 of the solid. This engagement surface 30 comprises a primary seal of the male sealing face 24.

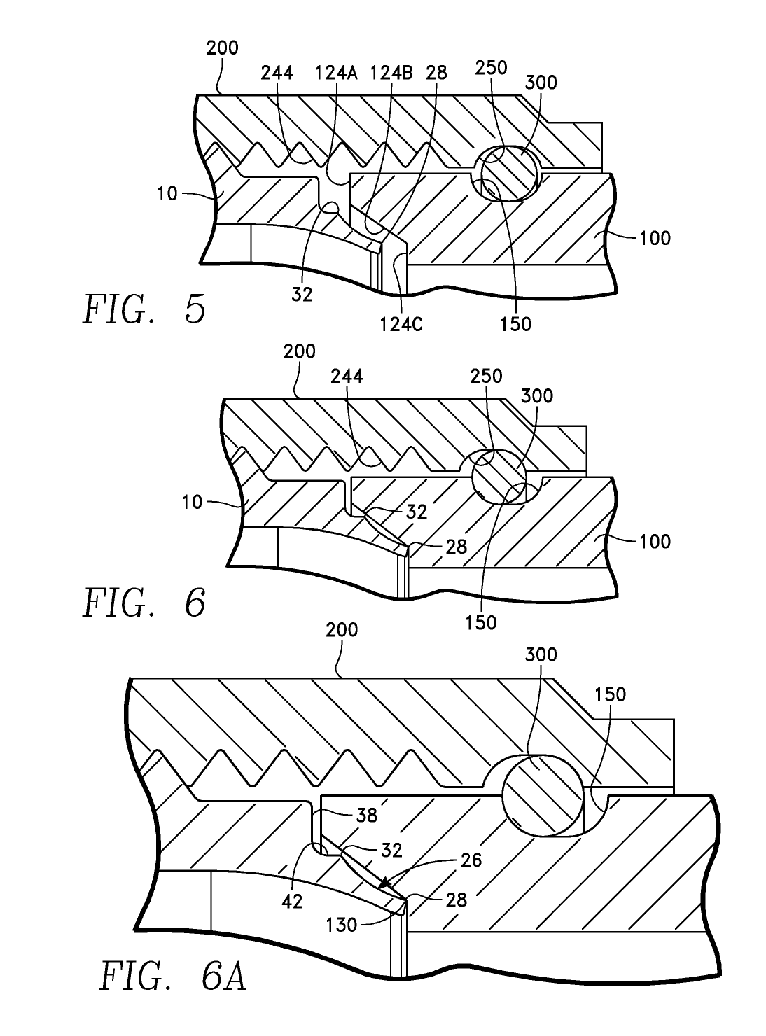

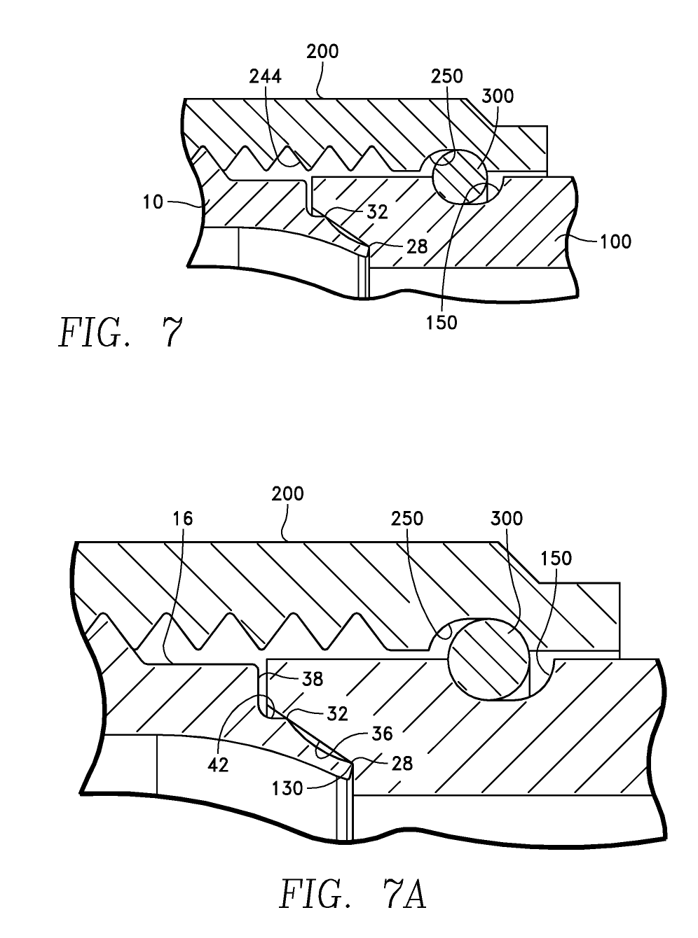

As shown in greater detail in FIGS. 6A and 7A, first sealing member 26 has a leading edge 28 which defines engagement surface 30. The male sealing face 24 further comprises a second sealing member 32, which extends circumferentially around the sealing face and defines a second circumference. As shown in the figures, the second sealing member 32, when viewed in section, has a crest-shaped profile, with the peak of the crest pointing radially outward generally toward the outside wall 16. A secondary sealing surface 34 is defined by the rotation of secondary sealing member 32 shown in the sectional view. Between the first circumference defined by the first sealing member 26 and the second circumference defined by the second sealing member 32, a first circumferential surface 36 is defined. When viewed in section, as in FIGS. 1 and 5-7, it can be seen that first circumferential surface 36 comprises a concavity which is oriented outwardly, generally toward the outside wall 16.

Male member 10 further comprises a shoulder member 38. Shoulder member 38 extends circumferentially around the male sealing face 24, thereby defining a shoulder member surface 40. As shown in the figures, the shoulder member surface 40 extends normally from the male member outside wall 16 toward, but not reaching, the male member inside wall 14. Between the second circumference defined by the second sealing member 32 and shoulder member 38, a second circumferential surface 42 is defined. When viewed in section, as in FIGS. 1 and 5-7, it can be seen that second circumferential surface 42 comprises a second concavity which is also oriented outwardly, generally toward the outside wall 16.

Female member 100 comprises has an elongated body having a central bore 112 which extends from end-to-end of the female member. Female member 100 has an inside wall 114 which bounds the central bore 112, and an outside wall 116. The female member 100 comprises a first end 118 which mates to the male member 10 and a second end 120, which will typically be attached to the end of a fluid bearing conduit 122. The first end 118 has a female sealing face 124. The female sealing face 124 is generally configured to conform to the profile of male sealing face 24. The female sealing face 124 generally has three discrete sealing surfaces. The first sealing surface 124A comprises the surface which aligns with shoulder member surface 40 of the male member 10. The second sealing surface 124B comprises a surface which generally aligns with the entire protruding lip structure which comprises both the first sealing member 26 and the secondary sealing member 32. The second sealing surface 124B, which comprises a substantial portion of the female sealing face 124, may be angled in a range from 35 to 40 degrees from the axis of the central bore 112 of the female member 100. The third sealing surface 124C, is generally normal to the axis of the central bore 112 of the female member 100.

Female sealing face 124 comprises a receiving surface 130 which is generally located at the vertex of the angle defined by the second sealing surface 124B and the third sealing surface 124C. As best shown in FIGS. 6A and 7A, upon application of axial force, leading edge 28 is pulled into the female sealing face 124 such that engagement surface 30 abuts receiving surface 130, stopping further penetration of male member 10 into female member 100. As shown in FIGS. 6A and 7A, the application of further axial force compresses the male sealing face 24, causing the secondary sealing member 32 to deflect outwardly and abut into a portion of the female sealing face 124, creating a secondary seal between the male sealing face 24 and the female sealing face 124.

Coupling member 200 is utilized to connect the male member 10 to female member 100. As shown in the figures, as coupling member 200 is made up onto the threads 44 of male member 10, the male sealing face 24 and female sealing face 124 are brought into abutting contact. As coupling member 200 is tightened, the protruding lip structure of the first sealing member 26 is brought into contact with receiving surface 130 such that further penetration of the female member 100 by the male member 10 is stopped, causing the secondary sealing member 32 to deflect outwardly, into sealing contact with a portion of the female sealing face 124. Coupling member 200 may comprise internal threads 244. Coupling member 200 may be attached to female member 100 by a locking ring 300. In this configuration, female member 100 comprises a first ring groove 150. Coupling member 200 likewise may comprise an opposite facing and matching second ring groove 250, such that a circumferential lock ring channel is defined by the axial alignment of the first ring groove 150 with the second ring groove 250, where lock ring 300 is disposed within the circumferential lock ring channel.

While the above is a description of various embodiments of the present invention, further modifications may be employed without departing from the spirit and scope of the present invention. Thus the scope of the invention should not be limited by the specific structures disclosed. Instead the true scope of the invention should be determined by the following appended claims.

What is claimed is:

1. A connector for connecting opposite facing fluid bearing conduits, the connector comprising:
a male member comprising a first elongated body having a central bore there through, a male member outside wall, a male member inside wall bounding the central bore, a first end and a second end, the first end comprising a male sealing face comprising a circumferential lip member protruding forwardly, the lip member comprising a leading edge having an engagement surface, the male sealing face further comprising a second sealing member extending circumferentially around the male sealing face defining a second circumference;
a female member comprising a second elongated body having a central bore there through, a female member outside wall, a female member inside wall bounding the central bore, a near end and a far end, the near end comprising a female sealing face, the female sealing face comprising a receiving surface for contact with the engagement surface; and
a coupling member which connects the male member to the female member, which, upon rotation, imposes an axial force which first causes the engagement surface to abut the receiving surface, and upon the application of further axial force, causes the second sealing member to be deflected into sealing contact with a portion of the female sealing surface.

2. The connector of claim 1 wherein the female member outside wall comprises a first ring groove and the coupling member comprises an internal surface comprising a second ring groove, where a circumferential lock ring channel is defined by the axial alignment of the first ring groove with the second ring groove, and the coupling member is attached to the female member by the disposition of a lock ring within the lock ring channel.

3. The connector of claim 1 wherein a substantial portion of the female sealing face is angled in a range from 35 to 40 degrees from the axis of the central bore of the female member.

4. The connector of claim 2 wherein the male member outside wall comprises external threads.

5. The connector of claim 4 wherein the coupling member comprises a first end for attaching to the male member and a second end for attaching to the female member, and the first end comprises internal threads corresponding to the external threads of the male member

6. A connector for connecting opposite facing fluid bearing conduits, the connector comprising:
a male member comprising a first elongated body having a central bore there through, a male member outside wall, a male member inside wall bounding the central bore, a first end and a second end, the first end comprising a male sealing face comprising a first sealing member extending around the male sealing face defining a first circumference, a second sealing member extending circumferentially around the male sealing face defining a second circumference, and a shoulder member extending circumferentially around the male sealing face defining a shoulder member surface, the shoulder member surface extending normally from the male member outside wall toward, but not reaching, the male member inside wall, wherein a first circumferential surface is defined between the first circumference and the second circumference and the first circumferential surface comprises a first concavity oriented toward the male member outside wall;
a female member comprising a second elongated body having a central bore there through, a female member outside wall, a female member inside wall bounding the central bore, a near end and a far end, the near end comprising a female sealing face, which upon application of an axial force, engages the first sealing member and the second sealing member in sealing contact; and
a coupling member which connects the male member to the female member, which, upon rotation, imposes the axial force for engaging the female sealing face into sealing contact with the first sealing member and the second sealing member.

7. The connector of claim 6 wherein a substantial portion of the female sealing face is angled in a range from 35 to 40 degrees from the axis of the central bore of the female member.

8. The connector of claim 6 wherein a second circumferential surface is defined between the second circumference and the shoulder member, and the second circumferential surface comprises a second concavity oriented toward the male member outside wall.

9. The connector of claim 6 wherein the female member outside wall comprises a first ring groove and the coupling member comprises an internal surface comprising a second ring groove, where a circumferential lock ring channel is defined by the axial alignment of the first ring groove with the second ring groove, and the coupling member is attached to the female member by the disposition of a lock ring within the lock ring channel.

10. The connector of claim 9 wherein the male member outside wall comprises external threads.

11. The connector of claim 10 wherein the coupling member comprises a first end for attaching to the male member and a second end for attaching to the female member, and the first end comprises internal threads corresponding to the external threads of the male member.

12. A connector for connecting opposite facing fluid bearing conduits, the connector comprising:
a male member comprising a first elongated body having a central bore there through, a male member outside wall, a male member inside wall bounding the central bore, a first end and a second end, the first end comprising a flared and segmented male sealing face comprising a primary sealing surface and a secondary sealing surface, the primary sealing surface defined by the rotation of a lip member protruding forwardly from the first end, the secondary sealing surface defined by the rotation of a crest in the sealing face, the crest axially displaced to the rear of the primary sealing surface, wherein a concavity oriented toward the outside wall is defined between the lip member and the crest;
a female member comprising a second elongated body having a central bore there through, a female member outside wall, a female member inside wall bounding the central bore, a near end and a far end, the near end comprising a female sealing face, which upon application of an axial force, first engages the primary sealing surface and second, upon application of additional axial force, engages the secondary sealing surface; and
a coupling member which connects the male member to the female member, which, upon rotation, imposes the axial force for engaging the female sealing face into sealing contact with the primary sealing surface and the secondary sealing surface.

13. The connector of claim 12 wherein a substantial portion of the female sealing face is angled in a range from 35 to 40 degrees from the axis of the central bore of the female member.
